(19) United States
(12) Patent Application Publication
(10) Pub. No.: US 2022/0007583 A1
(43) Pub. Date: Jan. 13, 2022

(54) FLEXIBLE FRONT RAMP FOR RIGID AND FLEXIBLE CUTTING PLATFORM

(71) Applicant: AGRISOLTEC - SOLUÇÕES TECNOLÓGICAS PARA AGRICULTURA LTDA, Campo Bom (BR)

(72) Inventors: Cassio FERNANDO CARVALHO, Sapucaia Do Sul (BR); Giovani BELO, Campo Bom (BR); Roberto ROESEL, Novo Hamburgo (BR); Neri PRESTES BATU, Porto Alegre (BR)

(21) Appl. No.: 17/291,910

(22) PCT Filed: Nov. 8, 2019
(86) PCT No.: PCT/BR2019/050483

§ 371 Date: May 6, 2021

(30) Foreign Application Priority Data
Nov. 9, 2018 (BR) 1020180730673

(51) Int. Cl. A01D 57/26; A01D 34/04

(52) U.S. Cl. CPC A01D 57/26; A01D 34/04

(57) ABSTRACT

This summary of the invention refers to the development of a ramp (flexible front guard) that is mounted to a cutting platform to prevent grain loss and dirt from entering the conveyor, consisting of a flexible material sheet (1), capable of being curved (2) near the cutting blade area (3) of a cutting platform (4), containing an inclined portion (8) and another curved portion (5) near the conveyor (6).

### FIELD OF THE INVENTION

The following descriptive report of invention refers to the development of a ramp (flexible front guard) to be mounted to a cutting platform in order to prevent grain losses and dirt from entering the conveyor.

### STATE OF THE ART

According to UNESP, the assembly of mechanisms that make up the cutting and feeding system of a combine harvester is usually known as platform. Harvesters can have platforms that cut the product, called cutting platforms, as well as pickup platforms and corn platforms. The system that feeds the threshing unit after cutting is commonly called feeder.

Depending on the crop, a harvester may be equipped with a conventional cutting platform, used for most harvesting jobs, except for corn and rice harvesting, or it may have a conveyor belt platform, widely used for rice. The cutting platform with a conveyor belt is similar to the conventional cutting platform, except that it has a conveyor belt between the cutter bar and the spinning auger. The conveyor belt helps gathering or feeding more product into the harvester.

Cutting platforms can be classified as rigid, flexible and floating.

In the most common rigid ones, the cutterbar does not have relative movement along its entire length.

Flexible platforms have been developed for low insertion crops, such as soybeans and beans, allowing the platform to follow small undulations on the soil surface.

To work on more sloped terrain or on terraces, there are lateral floating platforms, with an angular movement around 5° on each side.

On flexible platforms, i.e., platforms that do not keep the cutter bar straight, the cutter bar tries to follow the relief of the soil, making it even harder to keep the conveyor close enough to the ramp, so that grains or dirt do not fall inside the conveyor, without the conveyor coming into contact with the ramps that take the cut material to the upper part of the conveyor. These ramps are attached to the front of the platform, just behind the cutting blades, and extend until very close to the conveyors, so that harvested grains, as well as straw, dirt, and dust, do not fall into the conveyor.

A flexible cutting platform to follow ground contour in an agricultural harvesting machine is described in U.S. Pat. No. 7,478,521, where said cutting platform includes a plurality of platform sections positioned in end-to-end juxtaposed relation to each other. At least one platform section includes a frame, a plurality of float arms movably coupled with the frame, an endless belt carried by the plurality of float arms, and a cutterbar assembly carried by the plurality of float arms and movable in a localized manner in upwards and downwards directions.

A combine harvester cutting platform having flexible cutterbar is described in US 20070193243, which uses draper belts behind the cutterbar assembly to gently consolidate the severed crop materials and deliver them to a point of discharge and delivery, such as to the feeder house of a combine harvester. One embodiment has draper assemblies and a central conveyor fixed relative to the flexible cutterbar assembly, while another has the draper assemblies and central conveyer flexible with the cutterbar assembly.

A belt sealing crop deflector for a flexible draper platform is described in U.S. Pat. No. 9,814,183, relating to a belt guard assembly suitable for the harvesting platforms of the type that are carried on the front end of an agricultural combine. More specifically, belt guard assembly covers the void region at the front margin of the draper conveyor system and seals it against the entry of crop residue and foreign objects. The belt guard assembly is provided with a resilient seal strip that overlaps with the upper belt run, and with a rotary joint to permit flexibility between the cutterbar assembly and the draper conveyor.

Document US 20080276590 describes a harvesting machine that includes a harvesting header with a header frame, a cutterbar assembly attached to the header frame along the length thereof and configured to cut a crop, and a draper assembly positioned behind the cutterbar assembly and operable to receive severed crop material from the cutterbar assembly. The draper assembly includes a center draper that delivers crop material to a feeder house of the harvesting machine and oppositely spaced side drapers that deliver crop material to the center draper. The harvesting header is operable to flex and thereby follow an uneven terrain.

### Technical Problems

It is usual that during the harvesting process grains and dirt fall into the conveyor. The grains that fall from the platform are losses, while the dirt tends to accumulate on the rollers and, unless they are regularly cleaned, possibly cause the conveyor to slide out of the guide rails and get damaged, incurring high maintenance cost, as well as the need to interrupt the harvesting operation.

The procedure for cleaning rollers and removing dirt from inside the conveyor is time consuming as it requires removing several screws from the ramps, being then often neglected by machine operators, often leading to the need of conveyor replacement due to lack of cleaning of rollers and the inside of the conveyor.

As the conveyors are in motion and no space should be left for grains and dirt to enter the conveyor, there is a difficulty: if they are too far apart, it allows for grain loss and for dirt to get inside the conveyor and deposit on the rollers; if they are too close together, with the vibration they come into contact with the conveyor, wearing it out.

### Proposed Solution

Thus, considering the state of the art discussed above, one of the objectives of this invention is to solve the problem of grain and dirt entering the conveyor. For this purpose, a part that plays the role of ramps has been developed, having the advantage of being flexible so that, when in contact with the conveyor, it does not wear it out. As it is flexible, it does make the flexible system rigid (when the platform is flexible). Also, the upper part of the ramp can be pulled forward in order to remove any dirt that may have gotten past the seal, and just let it go that it will return to its initial position. As the material used is much lighter than the metal and polymer currently used, this solution would also reduce the platform weight.

### Description

Characterization of the present invention is made by means of representative drawings of the flexible front ramp for cutting platform, so that the product can be integrally reproduced by a suitable technique, allowing full characterization of the functionality of the object claimed.

Based on the figures designed to express the best or preferred embodiment of the product conceived, the descriptive part of the report is accompanied by detailed and consecutive numbering, which clarifies aspects that may be unclear in the adopted representation, so as to clearly determine the protection herein sought.

These figures are merely illustrative and may present variations, as long as they do not deviate from what has been initially claimed.

In this case we have:

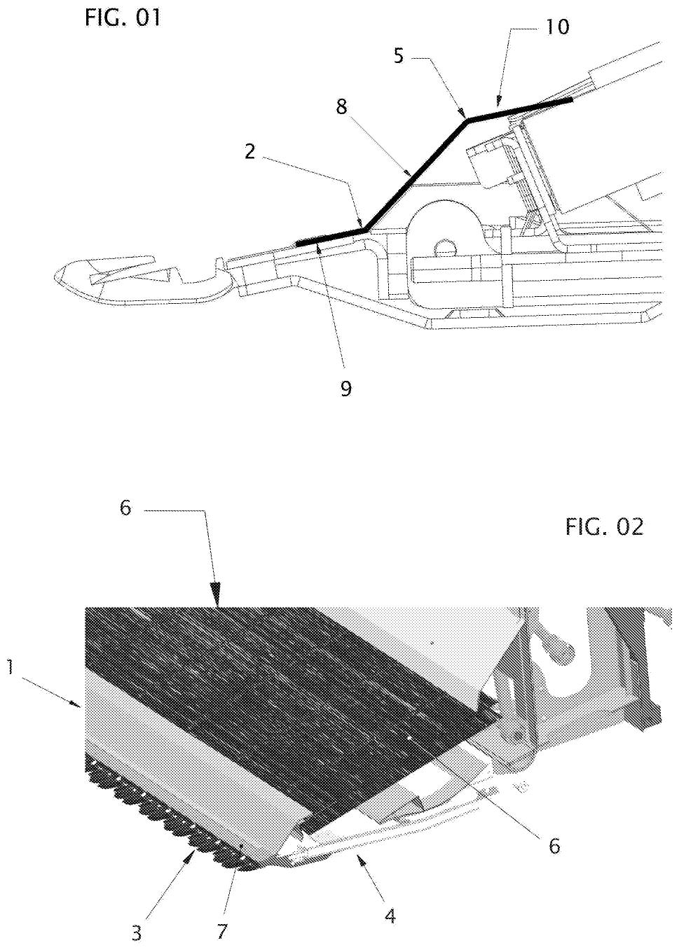

FIG. 1 shows a cross-section of a cutting platform, where the position of the ramp can be seen;

FIG. 2 shows a perspective view of a segment of the cutting platform, to which the flexible ramp is mounted;

FIG. 3 shows a perspective view of a cutting platform, where the flexible ramp is mounted along the entire length of the platform;

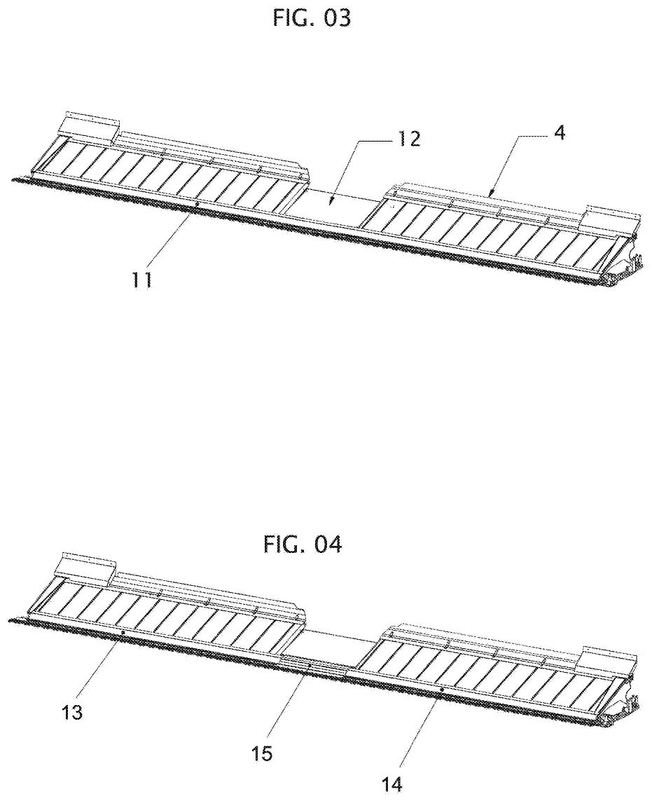

FIG. 4 shows a perspective view of a cutting platform, where two flexible ramps are mounted, one on each side of the platform;

FIG. 5 shows a detail of a cutting platform, where the flexible ramp is attached to the platform by fastening elements.

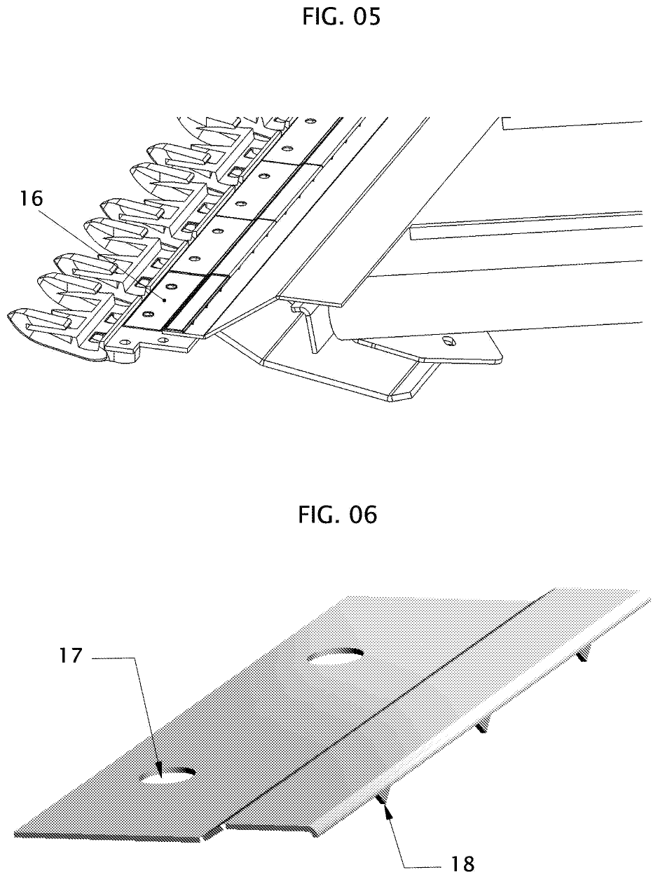

FIG. 6 shows a perspective view of one of these fastening elements.

A preferred embodiment of the invention comprises a sheet made of flexible material (1), capable of being curved (2) near the cutting system area (3) of a cutting platform (4), containing an inclined portion (8) and another curved portion (5) near the conveyor (6).

The flexible material sheet (1) is attached to the bar/ruler (7) of the cutting system (3) of a cutting platform (4), by means of fastening elements or plates (16), so that these plates (16) fasten an edge (9) of said flexible sheet (1), at the part that can be curved (2), so that the inclined part of the flexible material sheet (1) forms said ramp (8) for transporting the crop material to the conveyor (6).

The curved part (5) in the flexible material sheet (1) forms a flap (10) following the ramp (8), where said flap (10) advances over the conveyor (6), so as to prevent dirt and grain from falling into the conveyor (6).

The flexible material sheet (1) can be articulated/hinged at the fastening elements (16), so that the ramp section (8) and the flap (10) can be raised and lowered, exposing the inner part of the conveyor (6) for cleaning.

The flexible material sheet (1) can be made up of a single piece (11), i.e., said flexible material sheet (1) extends over the entire cutting platform (4), even covering the central conveyor (12). Another construction possibility is for the flexible material sheet to be divided into more sheets (13 and 14), covering or not (15) the central conveyor (12).

The entire flexible material ramp (11) or each of its parts (13 and 14) can be attached by means of fastening elements or plates (16), where said plates (16) have holes (17) for receiving screws to fasten said plates to the cutting platform (4), where each of these plates (16) contains claws (18) that grip into the ramp (11) or ramps (13 and 14) so as to keep them in place.

1. FLEXIBLE FRONT RAMP FOR RIGID AND FLEXIBLE CUTTING PLATFORM, characterized by consisting of a flexible material sheet (1), capable of being curved (2) near the cutting system area (3) of a cutting platform (4), having an inclined portion (8) and another curved portion (5) near the conveyor (6).

2. FLEXIBLE FRONT RAMP, according to claim 1 and characterized by having the flexible material sheet (1) attached to the bar/ruler (7) of the cutting system (3) of a cutting platform (4), by means of fastening elements or plates (16), so that these plates (16) fasten an edge (9) of said flexible sheet (1), at the part that can be curved (2), so that the inclined part of the flexible material sheet (1) forms said ramp (8) for transporting the crop material to the conveyor (6).

3. FLEXIBLE FRONT RAMP, according to claim 1 and characterized by having the curved part (5) in the flexible material sheet (1) form a flap (10) following the ramp (8), where said flap (10) advances over the conveyor (6).

4. FLEXIBLE FRONT RAMP, according to claim 1 and characterized by the possibility of having the flexible material sheet (1) articulated/hinged at the fastening elements (16), so that the ramp section (8) and the flap (10) can be raised and lowered, exposing the inner part the conveyor (6).

5. FLEXIBLE FRONT RAMP, according to claim 1 and characterized by having the flexible material sheet (1) made up of a single piece (11), i.e., said flexible material sheet (1) extends over the entire cutting platform (4), even covering the central conveyor (12)

6. FLEXIBLE FRONT RAMP, according to claim 5 and characterized by the flexible material sheet having other construction options, being divided into more sheets (13 and 14), covering or not (15) the central conveyor (12).

7. FLEXIBLE FRONT RAMP, according to claim 5 and characterized by the entire flexible material ramp (11) or each of its parts (13 and 14) being able to be attached by means of fastening elements or plates (16), where said plates (16) have holes (17) for receiving screws to fasten said plates to the cutting platform (4), where each of these plates (16) contains claws (18) that grip into the ramp (11) or ramps (13 and 14) so as to keep them in place.

8. FLEXIBLE FRONT RAMP, according to claim 7 and characterized by the plates (16) having claws (18) that grip into the ramp (11) or ramps (13 and 14).
